(19) United States
(12) Patent Application Publication
(10) Pub. No.: US 2010/0121791 A1
(43) Pub. Date: May 13, 2010

(54) SYSTEM, METHOD AND PROGRAM FOR PHARMACOKINETIC PARAMETER PREDICTION OF PEPTIDE SEQUENCE BY MATHEMATICAL MODEL

(75) Inventors: Sang-Kee Kang, Seoul (KR); Min-Kyung Kim, Gyeonggi-do (KR); Min-Kook Kim, Seoul (KR); Jun-Hyoung Kim, Yongin-si (KR); Jae-Min Shin, Uongin-si (KR); Cheol-Heui Yun, Seoul (KR); Ho-Kyoung Rhee, Seoul (KR); Dong-Hyun Jung, Gyeonggi-do (KR); Eun-Kyoung Jung, Seoul (KR); Seung-Hoon Choi, Suwon-si (KR); Yun-Jaie Choi, Seoul (KR); Jin-Huk Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: INSILICOTECH CO., LTD., Gyeonggi-do (KR)

(21) Appl. No.: 12/513,279

(22) PCT Filed: May 28, 2007
(86) PCT No.: PCT/KR2007/002568

§ 371 Date: May 1, 2009

(30) Foreign Application Priority Data
Nov. 3, 2006 (KR) 10-2007-0108504
Jan. 3, 2007 (KR) 10-2007-000076
Jan. 26, 2007 (KR) 10-2007-0008483

(51) Int. Cl. G06F 15/18; G06F 17/10; G06G 7/60

(52) U.S. Cl. 706/12; 703/2; 706/16; 703/11

(57) ABSTRACT

The present invention relates to the system, method and program for the pharmacokinetic parameter prediction of peptide sequence by the mathematical model.

The present invention is comprising the steps of acquiring a variety of peptide sequence having specific features by the experimental technique; acquiring, on the basis of the sequence, a variety of peptide sequences lacking the specific features; storing the acquired peptide sequences as each set respectively, followed by randomly extracting peptide sequences in the constant ratio to divide into a training set and a test set of mathematical model; allowing individual peptide sequence descriptor values and an activity value; training the set of training peptide by mathematical model; predicting pharmacokinetic parameter of the set of test peptide by the trained mathematical model; and validating the trained mathematical model. The present invention is useful because the pharmacokinetic parameter of peptide sequence, which are necessary for oral drug delivery, can be predicted in advance by not an experiment, but the program-storage medium, and cost and time can be reduced compared to an experiment as a result.

### TECHNICAL FIELD

The present invention relates to system, method and program for pharmacokinetic parameter prediction of peptide sequence by mathematical model. The system or method is comprising the steps of: acquiring a variety of peptide sequence having specific features by the experimental technique; acquiring, on the basis of the sequence, a variety of peptide sequences lacking specific features; storing the acquired peptide sequences as each set respectively, followed by randomly extracting peptide sequences in the constant ratio to divide into a training set and test set of mathematical model; allowing individual peptide sequence descriptor values and an activity value; training the set of training peptide to acquire mathematical model; testing pharmacokinetic parameter of the test set by the trained mathematical model; and validating the trained mathematical model.

### BACKGROUND ART

Recently, with regard to develop a new medicine, peptide is one of the promising substances due to its advantages of high effectiveness, non-toxicity and non-residing in human body, and the market of peptide is growing more and more. Various techniques for the selection of peptides having specific pharmacokinetic parameter have been developed and been utilized in order to develop a new medicine with these advantages of peptides.

However, previous techniques have many disadvantages. One of the disadvantages is that they would exhaust time and cost, because they depend mainly on the peptides-selection approach constituted by injecting the peptides directly into a living body to select the peptide having specific features.

To overcome the problem, the development of the quantitative model based upon the relationship between the structure and activity is considered as one of most promising approaches because it would reduce experimental cost and predict properties prior to develop a new medicine and product.

Even though there has been a program to predict several properties such as the intestinal permeability, solubility, toxicity and tissue affinity, which is indispensable to develop a new medicine, in the small organic compound, there has been no program to predict those properties of peptide sequence until now.

For the reason, it is required to develop new techniques for predicting various pharmacokinetic parameter of peptide and for enhancing the effectiveness of pharmaceuticals, in developing carriers or new medicines.

### Technical Problem

As the present invention has been developed in consideration of the above situation, one objective of the invention is to provide the system, method and program for predicting pharmacokinetic parameter, i.e. the intestinal permeability, tissue-targeting capacity and M cell-targeting capacity of peptide sequence, by mathematical model. Another objective of the invention is to provide a model for the prediction and the validation of various pharmacokinetic parameter of peptide sequence.

### Technical Solution

The system, method and program for pharmacokinetic parameter prediction of peptide sequence by mathematical model in accordance with the present invention is comprising a micro-computer (10); an input device (20); and an output device (30), in which the micro-computer is consisted of a program-storage medium (11), CPU (12) and input/output unit (13).

The program-storage medium (11) is comprising the programs: to translate the input peptide sequences of interest into amino acid descriptor; to predict its pharmacokinetic parameter by the trained mathematical model; to add the new input peptides sequences, which have specific features and an activity value on the specific pharmacokinetic parameter, to a previous set of peptide and then classify the set; to allow the newly added peptide the descriptor values and activity value; to train the training set by mathematical model; to predict the pharmacokinetic parameter of the test set; to validate the trained mathematical model.

In addition, the method for pharmacokinetic parameter prediction of peptide sequence by mathematical model is comprising the steps of; acquiring a variety of peptide sequence having specific features by the experimental technique; acquiring, on the basis of the sequence, a variety of peptide sequences lacking the specific features; storing the acquired peptide sequences as each set respectively, followed by randomly extracting peptide sequences in the constant ratio to divide into a training set and a test set of mathematical model; allowing individual peptide sequence descriptor values and an activity value; training the training peptide set by mathematical model; testing pharmacokinetic parameter of the test peptide set by the trained mathematical model; and validating the trained mathematical model.

The mathematical model is the method of quantitative relationship between structure and property, including: regression analysis, machine learning approach, multiple regression analysis using genetic algorithm, partial least squares method using genetic algorithm, partial least squares method using principle components analysis and multiple regression analysis using principle components analysis. The machine learning approach is one method selected from neural network, data mining, decision tree, inductive reasoning, case-based reasoning, pattern recognition, reinforcement learning, Bayesian network, hidden Markov model or probabilistic grammar rule, and especially neural network method.

The pharmacokinetic parameter of the peptide sequence means the intestinal permeability, tissue targeting and M cell targeting capacities. The descriptor value is quantitative value, which expresses the molecular structure, amino acid or peptide, and is at least any value of the descriptor selected from binary amino acid descriptor, VHSE amino acid descriptor, Z3 amino acid descriptor and Z5 amino acid descriptor.

The specific tissue targeting is to target at least any tissue selected from the liver, lung, kidney, spleen and cancer.

The data collected to construct the machine learning model are the data acquired by at least any experiment selected from the in-vivo, ex-vivo and in vitro experiment, and especially the data acquired by at least any one selected from in-vivo, ex-vivo and in vitro experiment by phage display technique. The peptide sequences are consisted of 2-12 peptides, more preferably 3-7 peptides. A species for applying the method for pharmacokinetic parameter prediction of peptide sequences by mathematical model, is Mammalia, more preferably human.

In addition, the program-storage medium for pharmacokinetic parameter prediction of peptide sequence by mathematical model is comprising the processes of: acquiring a variety of peptide sequences having specific features by the experimental technique; acquiring, on the basis of the sequence, a variety of peptide sequences lacking specific features; storing the acquired peptide sequences as each set respectively, followed by randomly extracting peptide sequences in the constant ratio to divide into a training set and test set of mathematical model; allowing individual peptide sequence descriptor values and an activity value; training the set of training peptides to acquire mathematical model; testing pharmacokinetic parameter of the test set by the trained mathematical model; and validating the trained mathematical model.

The objectives, characteristics and advantages of the present invention can be more easily understood by referring to the attached Drawings and the following Detailed Description.

### ADVANTAGEOUS EFFECTS

The present invention relates to the system, method and program for pharmacokinetic parameter prediction of peptide sequence by mathematical model. The invention is useful because the pharmacokinetic parameter of peptide sequence, which is necessary for oral drug delivery, would be predicted in advance by not an experiment but the program-storage medium, and as a result, cost and time would be reduced compared to an experiment.

### DESCRIPTION OF DRAWINGS

FIG. 1 is a block diagram showing one Example of the system for pharmacokinetic parameter prediction of peptide sequence by mathematical model in accordance with the present invention.

FIG. 2 is a flow chart showing one Example of the method for pharmacokinetic parameter prediction of peptide sequence by mathematical model in accordance with the present invention.

FIG. 3 is a flow chart showing one Example of the method for pharmacokinetic parameter prediction of peptide sequence by mathematical model in accordance with the present invention.

FIG. 4 is a flow chart showing the method of re-training the model for pharmacokinetic parameter prediction.

### EXPLANATION OF SIGNS IN THE ATTACHED DRAWINGS

10: micro-computer 11: program-storage medium
12: CPU 13: input/output unit
20: input device 30: output device

### BEST MODE

Hereinafter, the system, method and program for pharmacokinetic parameter prediction of peptide sequence by mathematical model in accordance with the present invention are described as Best Mode in detail referring to the attached Drawings.

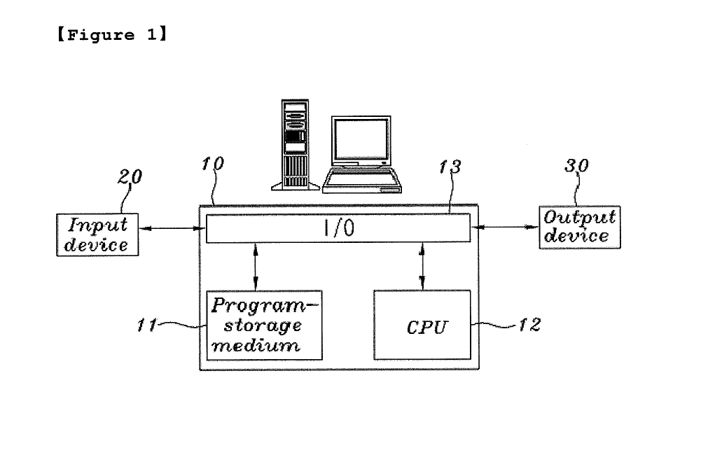

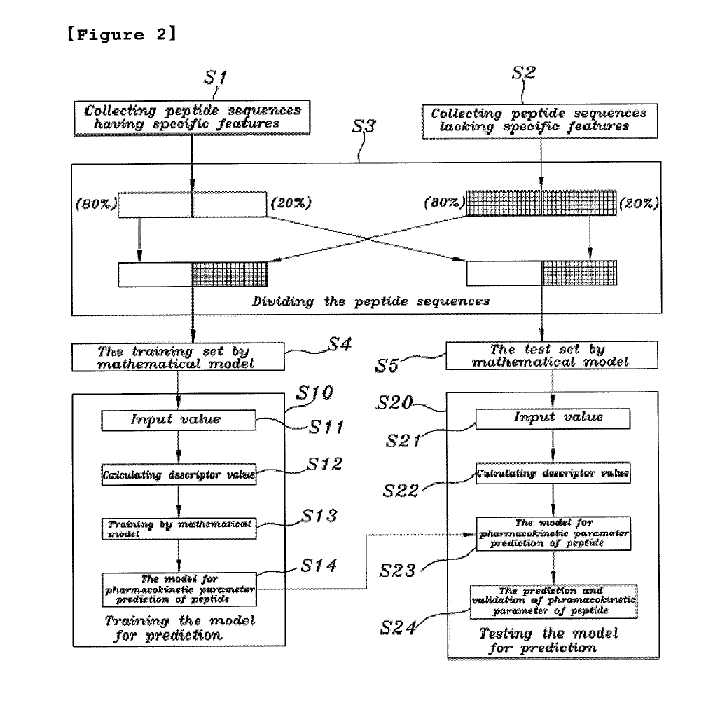

FIG. 1 is a block diagram showing one Example of the system for pharmacokinetic parameter prediction of peptide sequence by mathematical model, and FIG. 2 is a flow chart showing one Example of method for pharmacokinetic parameter prediction of peptide sequence by mathematical model.

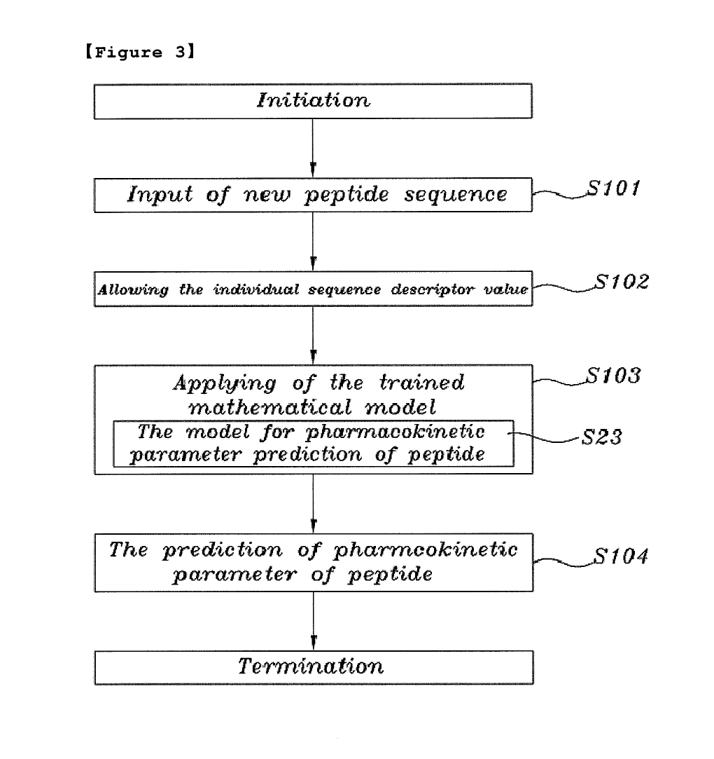

The following Example discloses the program for pharmacokinetic parameter prediction of peptide sequence, in which the specific feature of the peptide sequence is the intestinal permeability in FIG. 2 and FIG. 3.

### Example 1

The present Example shows the method for pharmacokinetic parameter prediction of peptide sequence, in which the specific feature of the peptide sequence is the intestinal permeability, as exemplars.

As FIG. 2 shows that the specific feature is the intestinal permeability, primarily a variety of intestinal barrier-permeable peptide sequences (number) are collected by the phage display experimental technique (S1). Here, the length of peptide sequence means the number of amino acids in one peptide, accordingly the length 3 of peptide sequence means peptide consisted of 3 amino acids. The number of collected peptide sequences is shown in below Table 1. In case of the peptide sequences consisted of 3 amino acids, the number of the peptide sequences acquired by the phage display experimental technique is 4252.

In addition, the phage display peptide library used in the above S1 step is ‘ph.D.-C7™ (New England BioLab.)’. It is comprising recombinant bacteriophage expressing over 0.1 billions of various peptides. The library is prepared by insertion of gene sequence into the pIII (one of coat protein)-producing gene residue of genome in M13 bacteriophage to express peptides of random amino acid sequences, followed by infection of E. coli. Meanwhile, the seven random amino acid sequences which are introduced into M13 phage are designed to carry cysteine residue at both sides, and to induce more strong interaction with target protein, by naturally forming disulfide bond when the peptide is expressed, resulting loop shape. The peroral phage display technique is as follows: administrating orally 1.2×10¹² pfu phage peptide library (approximately 1,000 copies for each peptide-coding phage recombinant) to overnight-starved rats, and after 1 hour, extracting the typical internal organs (liver, lung, kidney and spleen) from the mouse, and collecting and quantifying the phage, which is translocated from the intestinal lumen to the inner organs. The quantified peptide sequences are divided into the intestinal barrier-permeable sequences because it passed through the intestinal barrier.

TABLE 1
The number of peptide sequences.

| The length of | The number of peptide sequences | | | |
|---|---|---|---|---|
| peptide | Permeable | Impermeable | Training | Test |
| sequence | Peptide | Peptide | set | set |
| 3 | 4252 | 4252 | 6786 | 1718 |
| 4 | 3402 | 3402 | 5428 | 1376 |
| 5 | 2552 | 2552 | 4078 | 1026 |
| 6 | 1702 | 1702 | 2748 | 656 |
| 7 | 852 | 852 | 1400 | 304 |

Together with it, intestinal barrier-impermeable peptide sequences with three amino acids, are generated by using random amino acid selection program, and in case that there is no same peptide sequence compared with the set of the intestinal barrier-permeable peptide acquired by the experiment, the peptide sequences are classified into the set of the intestinal barrier-impermeable peptide sequences (S2). Here, the widely known program is used as the random amino acid selection program.

Next, the sets of peptide sequences are classified for machine learning training (S3). This step (S3) contains the process of making the populations of two sets as equal because the amount of the intestinal barrier-permeable peptide sequences is less compared to that of the impermeable peptide. In the step, total 4252 of the intestine barrier-impermeable peptides on the length 3 of peptide sequence were acquired as shown in Table 1.

Then, approximately 80% peptide sequences are randomly extracted from the set of intestinal barrier-permeable peptides, and about 80% peptide sequences from the set of the intestinal barrier-impermeable peptides, and the extracted peptide sequences are mixed, classified into the training peptide set by machine learning approach (S4).

Like the S4 step, the remnant (about 20%) in the set of the intestinal barrier-permeable peptides and the remnant (about 20%) in the set of the intestinal barrier-impermeable peptides are all mixed, classified into the test peptide set for machine learning approach (S5).

As shown in Table 1, the number of peptides in the training set by machine learning approach is 6786 and the number of peptides in the test set is 1718 in case of the length 3 of peptide sequence.

In the next step (S10), the training set is trained by machine learning approach and the model for prediction of the intestinal permeability is acquired. As the step of changing input order of the set of the intestinal barrier-permeable peptides and impermeable peptide sequence with the same ratio to go into the machine learning training process one after the other, the order of sequences in the training set by machine learning approach is changed (S11).

Subsequently, each peptide sequence, which is included in the training set by machine learning approach, is translated into amino acid descriptor value (S12). Here, the amino acid descriptor value is the value of any one selected from binary amino acid descriptor, VHSE amino acid descriptor, Z3 amino acid descriptor and Z5 amino acid descriptor. In addition, the binary amino acid descriptor is expressed as 20 digits consisted of 19 units of “0” and 1 unit of “1” regarding one amino acid, and each amino acid is designed to have different positioning order of “1” value. The length 3 of peptide sequence is consisted of sixty descriptors, and the activity value of the intestinal barrier-permeable peptide is expressed as 0.9, whereas that of impermeable peptide as 0.1.

In this manner, the translation of each peptide sequence into descriptor value may be accomplished by VHSE amino acid descriptor, and the defined values on each amino acid are shown in below Table 2. VHSE amino acid descriptor is consisted of 8 descriptors per one amino acid, and the descriptors are known as showing its hydrophobicity, electronic and steric properties in amino acids, and the length 3 of peptide sequence is consisted of 24 input values.

TABLE 2
VHSE amino acid descriptor

| | | Amino Acids | | | | | | | |
|---|---|---|---|---|---|---|---|---|---|
| | | VHSE 1 | VHSE 2 | VHSE 3 | VHSE 4 | VHSE 5 | VHSE 6 | VHSE 7 | VHSE 8 |
| Ala | A | 0.15 | −1.11 | −1.35 | −0.92 | 0.02 | −0.91 | 0.36 | −0.48 |
| Arg | R | −1.47 | 1.45 | 1.24 | 1.27 | 1.55 | 1.47 | 1.30 | 0.83 |
| Asn | N | −0.99 | 0.00 | −0.37 | 0.69 | −0.55 | 0.85 | 0.73 | −0.80 |
| Asp | D | −1.15 | 0.67 | −0.41 | −0.01 | −2.68 | 1.31 | 0.03 | 0.56 |
| Cys | C | 0.18 | −1.67 | −0.46 | −0.21 | 0.00 | 1.20 | −1.61 | −0.19 |
| Gln | Q | −0.96 | 0.12 | 0.18 | 0.16 | 0.09 | 0.42 | −0.20 | −0.41 |
| Glu | E | −1.18 | 0.40 | 0.10 | 0.36 | −2.16 | −0.17 | 0.91 | 0.02 |
| Gly | G | −0.20 | −1.53 | −2.63 | 2.28 | −0.53 | −1.18 | 2.01 | −1.34 |
| His | H | −0.43 | −0.25 | 0.37 | 0.19 | 0.51 | 1.28 | 0.93 | 0.65 |
| Ile | I | 1.27 | −0.14 | 0.30 | −1.80 | 0.30 | −1.61 | −0.16 | −0.13 |
| Leu | L | 1.36 | 0.07 | 0.26 | −0.80 | 0.22 | −1.37 | 0.08 | −0.62 |
| Lys | K | −1.17 | 0.70 | 0.70 | 0.80 | 1.64 | 0.67 | 1.63 | 0.13 |
| Met | M | 1.01 | −0.53 | 0.43 | 0.00 | 0.23 | 0.10 | −0.86 | −0.68 |
| Phe | F | 1.52 | 0.61 | 0.96 | −0.16 | 0.25 | 0.28 | −1.33 | −0.20 |
| Pro | P | 0.22 | −0.17 | −0.50 | 0.05 | −0.01 | −1.34 | −0.19 | 3.56 |
| Ser | S | −0.67 | −0.86 | −1.07 | −0.41 | −0.32 | 0.27 | −0.64 | 0.11 |
| Thr | T | −0.34 | −0.51 | −0.55 | −1.06 | −0.06 | −0.01 | −0.79 | 0.39 |
| Trp | W | 1.50 | 2.06 | 1.79 | 0.75 | 0.75 | −0.13 | −1.01 | −0.85 |
| Tyr | Y | 0.61 | 1.61 | 1.17 | 0.73 | 0.53 | 0.25 | −0.96 | −0.52 |
| Val | V | 0.76 | −0.92 | −0.17 | −1.91 | 0.22 | −1.40 | −0.24 | −0.03 |

Continuously, training by machine learning approach is carried out by using the experimental values, on whether or not the set of training peptides by machine learning passed through the intestinal barrier, and by using descriptor values on the peptide sequence as input values (S13). Here, neural network, data mining, decision tree, case-based reasoning, pattern recognition and reinforcement learning are used as the method of machine learning approach. For example, in case that feed forward neural network is used, training the training set by feed forward neural network learning approach is conducted. The architecture of feed forward neural network is composed of the input layer, hidden layer and output layer. In addition, the input layer is consisted of the input nodes, and the number of the input nodes would be determined in a way of multiplying the length of peptide sequence by the number of descriptor value, and one input node is real number or integer as one descriptor figure. The hidden layer has 0-2 hidden nodes per one hidden layer, and the output layer has one output node. When using the 20 digits binary amino acid descriptor on the length 3 of peptide sequence, the structure of feed forward neural network is consisted of 60 input nodes, which each input value of the nodes is 60 descriptor values, “0” or “1”, made in the S12 step. The structure of feed forward neural network on all length of peptide sequence may be constructed with the output layer having one output node without hidden layer.

And then, the model for prediction of the intestinal permeability of peptide sequence is acquired by appropriate machine learning approach of the S13 step (S14).

Subsequently, by using the model for prediction of the intestinal permeability (S14) and the test set obtained from the S5 step, the prediction value on the intestinal barrier permeability is acquired, and then the model for prediction of the intestinal permeability is tested and evaluated from a comparison between the experimental value and the prediction value (S20). The S20 step is composed of S21-S24 steps, namely, input value for test of the machine learning model is prepared (S21). In S21 step, the test set obtained from the S5 step is used as it is.

Continuously, each peptide sequence included in the test set of machine learning approach is translated into the descriptor value (S22). At that time, the descriptor should be same with the descriptor used in the training step (S13).

Subsequently, the amino acid descriptor value on peptide sequence is used as input value of peptides in the test set of machine learning approach, and the model for prediction of the intestinal permeability is acquired (S23).

And then, the prediction value is acquired by the test set in machine learning approach, and the model for prediction of the intestinal permeability, acquired in the S23 step, is tested by using the prediction value, and those result was shown in Table 3 (S24).

The S24 step is accomplished by means of training the model in machine learning approach using the 20 digits binary amino acid descriptor in S22 step, and the result are shown in Table 3.

TABLE 3
The result of test the model for prediction of
the intestinal permeability

| The | Receiver Operating Characteristic score(ROC score) | | | |
|---|---|---|---|---|
| length | random change of input | | | |
| of | order | | 5 section of whole set | |
| peptide | Training | | Training | |
| sequence | set(80%) | Test set(20%) | set(80%) | Test set(20%) |
| 3 | 0.8885 ± 0.0014 | 0.8876 ± 0.0056 | 0.8894 ± 0.0035 | 0.8855 ± 0.0152 |
| 4 | 0.7203 ± 0.0065 | 0.6907 ± 0.0068 | 0.7242 ± 0.0047 | 0.7059 ± 0.0173 |
| 5 | 0.7475 ± 0.0047 | 0.7212 ± 0.0140 | 0.7471 ± 0.0032 | 0.7279 ± 0.0070 |
| 6 | 0.7813 ± 0.0068 | 0.7444 ± 0.0244 | 0.7870 ± 0.0033 | 0.7447 ± 0.0136 |
| 7 | 0.8228 ± 0.0457 | 0.7707 ± 0.0209 | 0.8452 ± 0.0060 | 0.7884 ± 0.0412 |

As shown in Table 3, Receiver Operating Characteristic score on the length 3 of peptide sequence was 0.8885±0.0014 in the training set, 0.8876±0.0056 in the test set, as a result that the input value of feed forward neural network is changed randomly and tested 5 times. The results, which is acquired by means that the whole set is 5 sectioned and 4 sections are used in the training set and the rest 1 section is used in the test set and the sections are tested by being changed in turn, are that Receiver Operating Characteristic score on the length of peptide sequence was 0.8894±0.0035 in the training set, 0.8855±0.0152 in the test set.

The S24 step is conducted by training the model by machine learning approach using VHSE amino acid descriptor in the S22 step, and the result are shown in Table 4.

TABLE 4
The results of test on the model for
prediction of the intestinal permeability.

| The | Receiver Operating Characteristic score(ROC score) | | | |
|---|---|---|---|---|
| length | random change of | | 5 section of whole | |
| of | input order | | set | |
| peptide | Training | | Training | |
| sequence | set(80%) | Test set(20%) | set(80%) | Test set(20%) |
| 3 | 0.8371 ± 0.0025 | 0.8305 ± 0.0121 | 0.8358 ± 0.0024 | 0.8321 ± 0.0098 |
| 4 | 0.6937 ± 0.0069 | 0.6828 ± 0.0099 | 0.7032 ± 0.0040 | 0.6930 ± 0.0148 |
| 5 | 0.7129 ± 0.0071 | 0.6833 ± 0.0158 | 0.7149 ± 0.0031 | 0.7014 ± 0.0128 |
| 6 | 0.7460 ± 0.0080 | 0.7184 ± 0.2445 | 0.7537 ± 0.0032 | 0.7299 ± 0.0156 |
| 7 | 0.7964 ± 0.0074 | 0.7497 ± 0.0170 | 0.7999 ± 0.0062 | 0.7605 ± 0.0220 |

As shown in Table 4, Receiver Operating Characteristic score on the length 3 of peptide sequence was 0.8371±0.0025 in the training set, 0.8305±0.0121 in the test set, as a result that the input value of feed forward neural network is changed randomly and tested 5 times. The results, which is acquired by means that the whole set is 5 sectioned, 4 sections are used in the training set and the rest 1 section is used in the test set and the sections are tested by being changed in turn, are that Receiver Operating Characteristic score on the length 3 of peptide sequence was 0.8358±0.0024 in the training set, 0.8321±0.0098 in the test set.

Next, 5 times test was conducted using binary descriptor on amino acid in order to verify whether feed forward neural network model distinguishes the intestinal barrier-permeable peptide sequences and impermeable peptide sequences by chance or whether the correct model by learning approach is made when the set of the intestinal barrier-permeable permeability peptides in the S24 step is substituted for the randomly selected set of the intestinal barrier-impermeable peptides with same number, followed by training the model by feed forward neural network using them, and the result are shown in Table 5.

TABLE 5
The results of test on the model for
prediction of intestinal permeability

| | |
|---|---|
| | Receiver Operating |
| | Characteristic |
| The length of | score(ROC score) |

| peptide sequence | Training set(80%) | Test set(20%) |
|---|---|---|
| 3 | 0.5705 ± 0.0024 | 0.4935 ± 0.0079 |
| 4 | 0.5745 ± 0.0070 | 0.4970 ± 0.0244 |
| 5 | 0.5947 ± 0.0021 | 0.4989 ± 0.0114 |
| 6 | 0.6156 ± 0.0096 | 0.4849 ± 0.0353 |
| 7 | 0.6959 ± 0.0105 | 0.4969 ± 0.0216 |

As shown in Table 5, Receiver Operating Characteristic score on the length 3 of peptide sequence was low as 0.5705±0.0024 in the training set, 0.4935±0.0079 in the test set.

In addition, 5 times test was conducted using VHSE amino acid descriptor on amino acid and the results are shown in Table 6.

TABLE 6
The results of test on the model for
prediction of intestinal permeability

| | |
|---|---|
| | Receiver Operating |
| | Characteristic |
| The length of | score(ROC score) |

| peptide sequence | Training set(80%) | Test set(20%) |
|---|---|---|
| 3 | 0.5523 ± 0.0037 | 0.5171 ± 0.0142 |
| 4 | 0.5521 ± 0.0080 | 0.4968 ± 0.0197 |
| 5 | 0.5564 ± 0.0041 | 0.4807 ± 0.0213 |
| 6 | 0.5727 ± 0.0050 | 0.4750 ± 0.0234 |
| 7 | 0.6265 ± 0.0094 | 0.4926 ± 0.0155 |

As shown in Table 6, Receiver Operating Characteristic score on the length 3 of peptide sequence was low as 0.5523±0.0037 in the training set, 0.5171±0.0142 in the test set. As shown in Table 6, the result means that the model by machine learning approach is not made when false intestinal barrier-permeable peptide is used as a input value through the Example using two different descriptors likewise and the result shows that the model by feed forward neural network, which is composed of the input layer, hidden layer and output layer, actually distinguished the peptide sequence of the intestinal barrier-permeable peptide and impermeable peptide.

The FIG. 3 is a flow chart showing the method for the pharmacokinetic parameter prediction of new peptide sequence by machine learning approach. Firstly, the peptide sequences of interest are inputted into the input device (20), and stored in the program-storage medium (11) (S101).

Next, each input peptide sequence is translated into descriptor values required in the trained prediction model (S23) through the process shown in FIG. 2 (S102).

And then, the translated descriptor value is applied to the model for the pharmacokinetic parameter prediction (S103), composed of the trained model for prediction (S23).

The output is whether the new peptide sequence, which user input to know the pharmacokinetic parameter, passed through the intestinal barrier or not (S104).

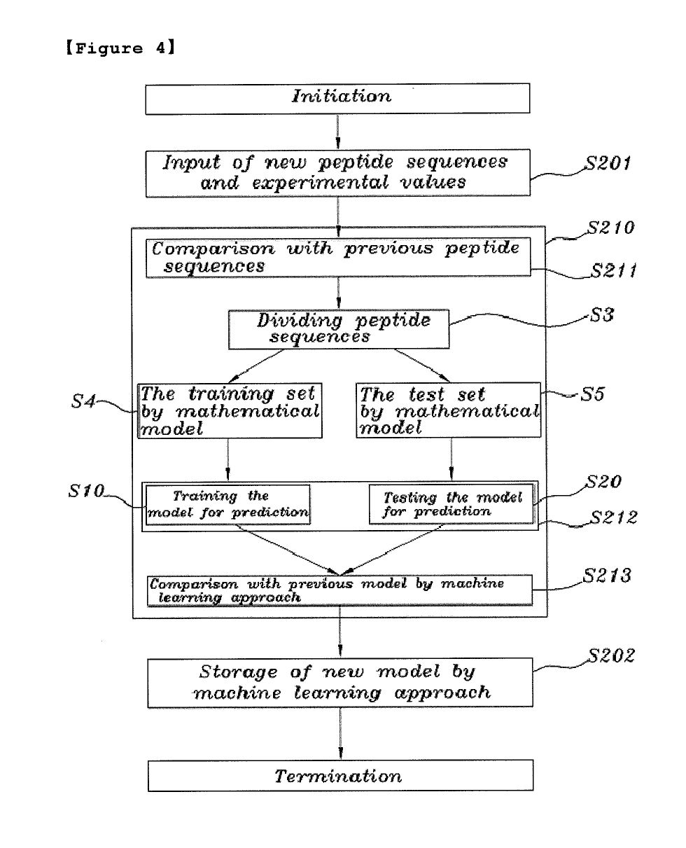

As FIG. 4 is a flow chart showing the method for re-training the model for predicting the pharmacokinetic parameter in accordance with the invention. Firstly, new intestinal barrier-permeable peptide sequences and impermeable peptide, having the activity value on the intestinal permeability by the experimental technique, are inputted into the input device (20), and stored in the program-storage medium (11) (S201).

Subsequently, after the model by machine learning approach is trained through S3-S5, S10 and S20 steps in FIG. 2, the model is validated and compared with the previous machine learning model (S210) to obtain the comparison value. Primarily, after the testing whether the new input peptide sequences are same as sequence already under earmark or not, the input sequences are stored by adding the sequences to the set of the intestinal barrier-permeable peptides or to the set of the intestinal barrier-impermeable peptides depending on the activity value, respectively (S211).

Next, the new input peptide sequences are added to the previously stored peptide sequences and the peptide sequences are divided into the training set and the test set by machine learning approach as S3 step, S4 step and S5 step in FIG. 2. And the model for prediction of the intestinal permeability is trained by machine learning approach in S10 step, and tested by machine learning approach in S20 step. (S212)

And then, Receiver Operating Characteristics Score of the previously stored model for prediction of the intestinal permeability is compared with that of the model for prediction of the intestinal permeability acquired in S212 step (S213 step).

Subsequently, Receiver Operating Characteristics score, which is calculated in S213 step, is provided with user as the output and the user stores the newly-trained model for prediction of the intestinal permeability on basis of the output (S202).

Accordingly, the user can re-train and test the model for prediction, based on mathematical model, using the newly-acquired peptide sequence through the experiment.

### MODE FOR INVENTION

### Example 2

The present Example describes the program for pharmacokinetic parameter prediction of peptide sequence in which the peptide sequence has specific feature of tissue targeting in FIGS. 2 and 3.

The present Example shows the method for the pharmacokinetic parameter prediction of peptide sequence in which the peptide sequence has tissue targeting feature, as one Exemplar of the pharmacokinetic parameter prediction. The specific feature in the FIG. 2 is tissue targeting, and a variety of specific tissue targeting peptide sequences (number) are collected by phage display experimental technique as shown in FIG. 2 (S1). Here, the length of peptide sequence means the number of amino acids in one peptide, accordingly the length 7 of peptide sequence indicates peptide consisted of 7 amino acids. The number of collected peptide sequences is shown in Table 7-10.

TABLE 7
The number of liver tissue targeting peptide
sequences

The number of peptides

| The length of | The liver | The liver | | |
|---|---|---|---|---|
| peptide | tissue | tissue non- | Training | Test |
| sequence | targeting | targeting | set | set |
| 3 | 1,110 | 1,110 | 1,766 | 454 |
| 5 | 666 | 666 | 1,066 | 266 |
| 7 | 222 | 222 | 348 | 90 |

TABLE 8
The number of lung tissue targeting peptide
sequences

The number of peptides

| The length of | The lung | The lung | | |
|---|---|---|---|---|
| peptide | tissue | tissue non- | Training | Test |
| sequence | targeting | targeting | set | set |
| 3 | 1,090 | 1,090 | 1,732 | 448 |
| 5 | 654 | 654 | 1,042 | 266 |
| 7 | 218 | 218 | 348 | 88 |

TABLE 9
The number of kidney tissue targeting peptide
sequences

The number of peptides

| The length | The kidney | The kidney | | |
|---|---|---|---|---|
| of peptide | tissue | tissue non- | Training | Test |
| sequence | targeting | targeting | set | set |
| 3 | 1,040 | 1,040 | 1,658 | 422 |
| 5 | 624 | 624 | 990 | 258 |
| 7 | 208 | 208 | 332 | 84 |

TABLE 10
The number of spleen tissue targeting peptide
sequences

The number of peptides

| The length | The spleen | The spleen | | |
|---|---|---|---|---|
| of peptide | tissue | tissue non- | Training | Test |
| sequence | targeting | targeting | set | set |
| 3 | 1,020 | 1,020 | 1,626 | 414 |
| 5 | 612 | 612 | 974 | 250 |
| 7 | 204 | 204 | 326 | 82 |

In case of the length 7 of peptide consisted of 7 amino acids, the number of liver tissue targeting peptide sequences acquired by phage display experimental technique is 222. The number of lung tissue targeting peptides is 218, and that of kidney tissue targeting peptides is 208, and the number of spleen tissue targeting peptides is 204.

In addition, the phage display peptide library used in the above S1 step is ‘ph.D.-C7C™ (New England BioLab.)’. It is comprising recombinant bacteriophage expressing over 0.1 billions of various peptides. The library is prepared by insertion of gene sequence into the pIII (one of coat protein)-producing gene residue of genome in M13 bacteriophage to express peptides of 7 random amino acid sequences, followed by infection of E. coli. Meanwhile, the seven random amino acid sequences which are introduced into M13 phage are designed to carry cysteine residue at both sides, and to induce more strong interaction with target protein, by naturally forming disulfide bond when the peptide is expressed, resulting loop shape. The peroral phage display technique is as follows: administrating orally 1.2×10¹² pfu phage peptide library (approximately 1,000 copies for each peptide-coding phage recombinant) to overnight-starved rats, and after 1 hour, extracting the typical internal organs (liver, lung, kidney and spleen) from the mouse, and collecting and quantifying the phage, which is translocated from the intestinal lumen to the inner organs.

Together with it, seven amino acids, on the length 7 of tissue targeting peptide sequence, are generated by random amino acid selection program, and in case that there is no same peptide sequence compared with the set of the specific tissue targeting peptide acquired by the experiment, the peptide sequences are classified into the set of the specific tissue non-targeting peptide (S2). Here, the widely known program is used as the random amino acid selection program.

Next, the sets of peptide sequences are classified for machine learning training (S3 step). This step (S3 step) contains the process of making the populations of two sets as equal because the amount of the set of the specific tissue targeting peptides is less compared to that of the non-targeting. In the step, total 222 of liver tissue non-targeting peptide on the length 7 of peptide sequence were acquired as shown in the above Table 7. The number of lung tissue non-targeting peptides is 218, the number of kidney tissue non-targeting peptides is 208, and the number of spleen tissue non-targeting peptides is 204 according to the same experimental technique.

And then, approximately 80% peptide sequences are randomly extracted from the set of the specific tissue targeting peptides, and about 80%, peptide sequences from the set of the specific tissue non-targeting peptides, and then the peptide sequences are mixed, classified into the set of peptide for training the machine learning (S4 step).

Like the S4 step, the remnant about 20% in the set of the specific tissue targeting peptides and the remnant about 20% in the set of the specific tissue non-targeting peptides are all mixed, classified into the test peptide set for the machine learning (S5 step)

As shown in Table 7, the number of peptides for training the machine learning is 354 and the number of peptides for verifying the machine learning is 90 in case of the length 7 of peptide sequence. As shown in Table 8-10, the peptides are classified into training set and test set for the lung, kidney and spleen according to the same technique.

In the next step (S10 step), the model for prediction of the tissue targeting peptide is trained and acquired with the set of training machine learning which is acquired by S4 step. That is, as transferring input order of the set of the specific tissue targeting peptides, for the specific tissue targeting peptide and non-targeting peptide with the same ratio to go into the machine learning training process one after the other, the input data for training machine learning model is inputted by adjusting the order of the machine learning training (S11 step).

Subsequently, each peptide sequence, which is included in the set for training machine learning, is translated into amino acid descriptor (S12 step). Here, the amino acid descriptor is any one selected from binary amino acid descriptor, VHSE amino acid descriptor, Z3 amino acid descriptor and Z5 amino acid descriptor, and the binary amino acid descriptor is expressed as 20 digits consisted of 19 units of “0” and 1 unit of “1” regarding one amino acid, and each amino acid is designed to have different positioning order of “1” value. The length 7 of peptide sequence is consisted of one hundred forty descriptors, and the activity value on the specific tissue targeting peptide is expressed as 0.9, whereas that of non-targeting peptide as 0.1.

Continuously, the machine learning training is carried out by using experimental values, on whether the set of training peptides by machine learning approach is targeting the specific tissue or not, and descriptor values on the peptide sequence as input values (S13 step). Here, the same method as mentioned in the above Example 1 is used as the method by machine learning approach.

And then, the model for the specific tissue targeting peptide sequence prediction is acquired by the appropriate machine learning training of the S13 step (S14).

Subsequently, by using the model for the specific tissue targeting (S14) prediction and the test set by machine learning approach (S5), the model for the specific tissue targeting peptide prediction is tested and evaluated from a comparison between the experimental value and the prediction value on the specific tissue targeting which is acquired (S20). The S20 step is composed of S21-S24 steps, namely, input value for test the model by machine learning approach is prepared first (S21 step). In S21 step, the test set by machine learning approach (S5) is used as it is.

Continuously, each peptide sequence included in the test set by machine learning approach is translated into the descriptor value (S22 step). At that time, the descriptor should be same with the descriptor used in the training step (S13).

Subsequently, the amino acid descriptor value on peptide sequence is used as input value in the set of test peptides by machine learning approach, and the model for the specific tissue targeting prediction is acquired (S23 step).

And then, the prediction value is acquired by the test set by machine learning approach, and by using the value the model for the specific tissue targeting prediction, acquired in the S23 step, is tested, and those result are shown in Table 11 (S24).

The S24 step is accomplished by means of training the model by machine learning approach using 20 digits binary amino acid descriptor as the descriptor value in S22 step, and the result are shown in Table 11.

In the case of liver tissue targeting peptide, the Receiver Operating Characteristic score on the length 7 of peptide sequence was 0.9207 in the training set, 0.6855 in the test set.

TABLE 11
The results of test on the model for the tissue targeting peptide prediction

| The | Receiver Operating Characteristic score (ROC score) | | | | | | | |
|---|---|---|---|---|---|---|---|---|
| length | liver | | lung | kidney | | spleen | | |
| of | Training | | Training | | Training | | Training | |
| peptide | set | Test set | set | Test set | set | Test set | set | Test set |
| sequence | (80%) | (20%) | (80%) | (20%) | (80%) | (20%) | (80%) | (20%) |
| 3 | 0.8307 | 0.7812 | 0.8588 | 0.8461 | 0.8623 | 0.8488 | 0.8555 | 0.8322 |
| 5 | 0.7725 | 0.6872 | 0.7583 | 0.6853 | 0.7988 | 0.7047 | 0.7870 | 0.7073 |
| 7 | 0.9207 | 0.6855 | 0.9276 | 0.6742 | 0.9447 | 0.7337 | 0.9479 | 0.6684 |

The result shows that the feed forward neural network model, composed of the input layer and hidden layer and output layer, actually distinguished the specific tissue targeting peptide and non-targeting peptide.

The FIG. 3 is a flow chart showing the method for the tissue targeting peptide sequence prediction by machine learning approach. Firstly the peptide sequence of interest is inputted into the input device (20), and stored in the program-storage medium (11) (S101).

Next, each input peptide sequence is translated into descriptor values required in the trained model for prediction (S23) through the process shown in FIG. 2 (S102 step).

And then, the translated descriptor value is applied to the model for pharmacokinetic parameter prediction (the S103 step), composed of the trained prediction model (S23).

The output is whether or not the new input peptide sequence target the tissue (S104 step).

The FIG. 4 is a flow chart showing the method for re-training the model for the tissue targeting prediction in accordance with the invention. Primarily, the new peptide sequences of the tissue targeting and tissue non-targeting, which has an activity value on the tissue targeting by an experimental technique, are injected through the input device (20), and stored in the program-storage medium (11) (S201).

Subsequently, the model by machine learning approach is trained through S3-S5, S10 and S20 steps in FIG. 2, and it is tested, and it is compared to the previous model by machine learning approach to obtain the comparison value (S210). First, it is tested whether or not the newly-input peptide sequence is same as sequence already under earmark, these sequences are stored by adding to the set of the specific tissue targeting peptides or to that of non-targeting peptides, depending on the activity value, respectively (S211).

Next, the newly input peptide sequence is added to the previously stored peptide sequences and the set of peptide sequences is divided into the training set by machine learning approach and the test set by machine learning approach in S3 step, S4 step and S5 step, and the model for the tissue targeting peptide prediction is trained and acquired by machine learning approach in S10 step, and tested by machine learning approach in S20 step (S212).

And then, Receiver Operating Characteristics score of the previously stored model for the tissue targeting peptide prediction is compared with that of the model for the tissue targeting peptide prediction acquired in the S212 step (S213).

Subsequently, Receiver Operating Characteristics score, which is calculated in the S213 step, is provided with user and the user stores the newly-trained model for the tissue targeting peptide prediction on basis of it (S202).

Accordingly, the user can re-train and test the prediction model based on mathematical model by the newly-acquired specific tissue targeting peptide sequence through the experiment.

### Example 3

The present Example discloses the program for the pharmacokinetic parameter prediction of peptide sequences in which specific feature of the peptide sequence is the M cell targeting in FIG. 2 and FIG. 3.

The present Example shows the method for the pharmacokinetic parameter prediction of the peptide sequences in which feature of peptide sequence is M cell targeting, as one Exemplar. FIG. 2 shows that specific feature is M cell targeting. Firstly a variety of peptide sequences (number), which is targeting the M cell, are collected by in vitro M cell model and phage display experimental technique (S1). Here, the length of peptide sequences means the number of amino acid in one peptide, and the length 7 of peptide sequences means peptide consisting seven amino acids. The number of collected peptide sequences is shown in Table 12.

TABLE 12
The number of the M cell targeting peptides

| | |
|---|---|
| The length of | The number of peptides |

| peptide | M cell | M cell non- | Training | Test |
|---|---|---|---|---|
| sequence | targeting | targeting | set | set |
| 3 | 1,225 | 1,225 | 1,930 | 520 |
| 4 | 980 | 980 | 1,568 | 392 |
| 5 | 735 | 735 | 1,174 | 296 |
| 6 | 490 | 490 | 782 | 198 |
| 7 | 245 | 245 | 396 | 94 |

In addition, the phage display peptide library used in S1 step is same with the library in Example 1.

The phage display technique is performed by means of conducting the transcytosis assay with the in vitro M cell model among 1.0×10¹¹ pfu of the phage peptide library (approximately 1,000 copies for each peptide-coding phage recombinant) to select the peptide sequence having high transcytosis activity.

Together with it, 7 amino acids on the length 7 of the M cell targeting peptide sequence are generated by random amino acid selection program, and in case that there is no same peptide sequence compared with the set of the M cell targeting peptides acquired in the experiment, the peptide sequences are classified into the set of the M cell non-targeting peptide sequences (S2 step). Here, the widely known program is used as the random amino acid selection program.

Next, the sets of peptide sequences are classified for training the machine learning (S3 step). This step (S3 step) contains the process of making the populations of two sets as equal because the amount of the M cell targeting peptide sequence is less compared to that of the non-targeting peptide. In the step, total 245 of the M cell non-targeting peptides with the length 7 of peptide sequence were acquired as shown in Table 12.

And then, approximately 80% peptide sequences are randomly extracted from the set of the M cell targeting peptides, and about 80% peptide sequences from the set of the M cell non-targeting peptides, and then the peptide sequences are mixed, classified into the training set of peptides by machine learning approach (S4).

Like S4 step, the remnant about 20% in the set of the M cell targeting peptides and about 20% in the set of the M cell non-targeting peptides are all mixed, classified into the test set of peptides by machine learning approach (S5 step).

As shown in Table 12, the number of peptides in the training set by machine learning approach is 396 and the number of peptides in the test set by machine learning approach is 94 in case of the length 7 of peptide sequence.

In the next step (S10 step), the model for the M cell targeting peptide prediction is trained and acquired by the training set by machine learning approach. That is, as it is the step of changing input order of the set of the M cell targeting peptides and non-targeting peptide sequence with the same ratio to go into the machine learning training process one after the other, the order of sequences in the training set by machine learning approach is changed (S11).

And then, each peptide sequence, which is included in the training set by machine learning approach, is translated into amino acid descriptor value (S12 step). Here, the amino acid descriptor value is one value of any one selected from binary amino acid descriptor, VHSE amino acid descriptor, Z3 amino acid descriptor and Z5 amino acid descriptor. The binary amino acid descriptor is expressed as 20 digits consisted of 19 units of “0” and 1 unit of “1” regarding one amino acid, and each amino acid is designed to have different positioning order of “1” value. The length 7 of peptide sequence is consisted of one hundred forty descriptors, and the activity value of the M cell targeting peptide is expressed as 0.9, whereas that of M cell non-targeting peptide as 0.1.

Likewise, the translation of each peptide sequence may be accomplished by VHSE amino acid descriptor, and the defined values on each amino acid are shown in Table 2.

Continuously, training by machine learning approach is carried out by experimental values, on whether or not the test peptides set by machine learning approach targeted the M cell, and descriptor values on the peptide sequence as input values (S13).

And then, the model for the M cell targeting prediction of peptide sequence is acquired by training by appropriate machine learning approach of S13 step (S14).

Subsequently, by using the model for the M cell targeting prediction of peptide (S14) and the test set obtained from the S5 step, the model for the M cell targeting prediction of peptide is tested and evaluated from a comparison between the experimental value and the prediction value on the M cell targeting which is acquired (S20). The S20 step is composed of S21-S24 steps, namely, input value for test of the machine learning model is prepared first (S21). In S21 step, the test set obtained from the S5 step is used as it is.

Continuously, each peptide sequence included in the test set of machine learning is translated into the descriptor value (S22). At that time, the descriptor should be same with the descriptor used in the training step (S13).

Subsequently, the amino acid descriptor value on peptide sequence is used as input value in the test peptides set of machine learning approach, and the model for the M cell targeting prediction is acquired (S23).

And then, the prediction value are acquired by the test set in machine learning approach and the model for the M cell targeting prediction acquired in the S23 step, is tested using the value, and those result are shown in Table 13 (S24).

The S24 step is conducted by training the model in machine learning approach by VHSE amino acid descriptor in S22 step, and the result are shown in Table 13.

The Receiver Operating Characteristic score on the length 3 of peptide sequence was 0.8678±0.0062 in the training set, 0.8609±0.0122 in the test set, as a result that the input value of feed forward neural network is changed randomly and it is verified 3 times.

TABLE 13
The result of test on the model for the M cell
targeting prediction

| | |
|---|---|
| | Receiver Operating |
| | Characteristic |
| The length of | score(ROC score) |

| peptide sequence | Training set(80%) | Test set(20%) |
|---|---|---|
| 3 | 0.8678 ± 0.0062 | 0.8609 ± 0.0122 |
| 4 | 0.7644 ± 0.0025 | 0.7020 ± 0.0155 |
| 5 | 0.7984 ± 0.0110 | 0.7544 ± 0.0172 |
| 6 | 0.8571 ± 0.0048 | 0.7248 ± 0.0132 |
| 7 | 0.9314 ± 0.0101 | 0.6871 ± 0.0064 |

The S24 step is conducted by training the model by machine learning approach using VHSE amino acid descriptor as the descriptor in the S22 step, and the result are shown in Table 14.

The Receiver Operating Characteristic score on the length 3 of peptide sequence was 0.8177±0.0079 in the training set, 0.7974±0.0187 in the test set, as a result that the input value of feed forward neural network is changed randomly and it is verified 3 times.

TABLE 14
The result of test on the model for the M cell
targeting prediction.

| | |
|---|---|
| | Receiver Operating |
| | Characteristic |
| The length of | score(ROC score) |

| peptide sequence | Training set(80%) | Test set(20%) |
|---|---|---|
| 3 | 0.8177 ± 0.0079 | 0.7974 ± 0.0187 |
| 4 | 0.7309 ± 0.0154 | 0.7064 ± 0.0083 |
| 5 | 0.8067 ± 0.0027 | 0.7449 ± 0.0193 |
| 6 | 0.8067 ± 0.0027 | 0.7433 ± 0.0205 |
| 7 | 0.8536 ± 0.0057 | 0.6710 ± 0.0464 |

The result shows that the feed forward neural network model composed of the input layer, hidden layer and output layer, actually distinguished the M cell targeting peptides and non-targeting peptides.

The FIG. 3 is a flow chart showing the method for the M cell targeting prediction of peptide sequence by machine learning approach. Firstly the peptide sequence of interest is inputted into the input device (20), and stored in the program-storage medium (11) (S101).

Next, each input peptide sequence is translated into descriptor value required in the trained prediction model (S23) through the process shown in FIG. 2 (S102)

And then, the translated descriptor value is applied to the model (S103) for pharmacokinetic parameter prediction, composed of the trained model for prediction (S23).

The output is whether or not the new input peptide sequences targeted the M cell (S104).

The FIG. 4 is a flow chart showing the method of re-training the model for the M cell targeting prediction in accordance with the invention. Firstly, new peptide sequences of the M cell targeting and non-targeting, has the activity value on the M cell targeting and is acquired by an experimental technique, are inputted into the input device (20), and stored in the program-storage medium (11) (S201).

Subsequently, after the model by machine learning approach is trained through S3-S5, S10 and S20 steps in FIG. 2, it is tested and it is compared to the previous model by machine learning approach to obtain the comparison value (S210). First, it is tested whether or not the newly-input peptide sequences are same as sequence already under earmark, these sequences are stored by adding to the set of the M cell targeting peptide or that of non-targeting peptide depending on the activity value, respectively (S211).

Next, the newly input peptide sequence is added to the previously stored peptide sequences and the set of peptide sequences is divided into the training set of peptide sequences and the test set of peptide sequences by machine learning approach of S3 step, S4 step and S5 step in the FIG. 2, and the model for the M cell targeting prediction of peptide is trained and acquired by machine learning approach in S10 step, and tested by machine learning approach in S20 step (S212).

And then, Receiver Operating Characteristics score of the previously stored model for the M cell targeting prediction of peptide is compared with that of the model for the M cell targeting prediction of peptide acquired in the S212 step (S213).

Subsequently, Receiver Operating Characteristics score, which is calculated in S213 step, is provided to user and the user stores the newly-trained model for the M cell targeting prediction of peptide on basis of it (S202).

Through these method, the user can re-train and test the prediction model based on mathematical model by the newly-acquired the M cell targeting peptide sequence with the experiment.

Although the invention has been described in connection with specific embodiments, it should be understood that the invention as claimed should not be unduly limited to these embodiments. Indeed, various modifications for carrying out the invention are obvious to those skilled in the art and are intended to be within the scope of the following claims.

### INDUSTRIAL APPLICABILITY

The present invention relates to the system, method and program for pharmacokinetic parameter prediction of peptide sequences by mathematical model. The present invention is applicable industrially, because the pharmacokinetic parameter of peptide sequences, which are necessary for oral drug delivery, can be predicted in advance by not an experiment but a program-storage medium, and as a result cost and time can be reduced compared to an experiment.

1. The system for pharmacokinetic parameter prediction of peptide sequence by mathematical model comprising the micro-computer (10), the input device (20) and the output device (30), in which the said micro-computer is consisted of the program-storage medium (11), CPU (12) and input/output unit (13).

2. The system of claim 1, wherein the program-storage medium (11) is comprising the programs to: translate the input peptide sequences of interest into amino acid descriptor; predict its pharmacokinetic parameter by the trained mathematical model; add the new input peptides sequences, which have specific features and an acquired activity value on the specific pharmacokinetic parameter, to a previous set of peptide and then divide the set; allow the added peptide the descriptor value and activity value; train the training set by mathematical model; predict the pharmacokinetic parameter of the test set; validate the trained mathematical model.

3. The method for pharmacokinetic parameter prediction of peptide sequence by mathematical model is comprising the steps of; acquiring a variety of peptide sequence having specific features by the experimental technique; acquiring, on the basis of the sequence, a variety of peptide sequences lacking the specific features; storing the acquired peptide sequences as each set respectively, followed by randomly extracting peptide sequences in the constant ration to divide into a training set and a test set of mathematical model; allowing individual peptide sequence descriptor values and an activity value; training the set of training peptide by mathematical model; predicting pharmacokinetic parameter of the set of test peptide by the trained mathematical model; and validating the trained mathematical model.

4. The method of claim 3, wherein the mathematical model is the method of quantitative relationship between structure and property, including: regression analysis, machine learning approach, multiple regression analysis using genetic algorithm, partial least squares method using genetic algorithm, partial least squares method using principle components analysis and multiple regression analysis using principle components analysis.

5. The method of claim 4, wherein the machine learning approach is one method selected from neural network, data-mining, decision tree, inductive logic, case-based reasoning, pattern recognition, reinforcement learning, Bayesian network, hidden Markov model or probabilistic grammar rule.

6. The method of claim 4, wherein the machine learning approach is the neural network method.

7. The method of claim 3, wherein the pharmacokinetic parameter of the peptide sequence is feature of any one selected from the intestinal permeability, the tissue targeting, the M cell targeting.

8. The method of claim 7, wherein the tissue is at least any one of the tissue selected from the liver, lung, kidney, spleen and cancer.

9. The method of claim 3, wherein the descriptor value is quantified the molecular structure, amino acid and peptide.

10. The method of claim 3, wherein the descriptor value is at least any one value of the descriptor selected from a binary amino acid descriptor, VHSE amino acid descriptor, Z3 amino acid descriptor and Z5 amino acid descriptor.

11. The method of claim 3, wherein the data for constructing the mathematical model is the data acquired by at least any one selected from in vivo, ex vivo and in vitro experiments.

12. The method of claim 3, wherein the data for constructing the mathematical model is the data acquired by at least any one selected from in vivo, ex vivo and in vitro experiments, especially by using the phage display technique.

13. The method of claim 3, wherein the peptide sequences are consisted of 2-12 peptides.

14. The method of claim 3, wherein the peptide sequences are consisted of 3-7 peptides.

15. The method of claim 3, wherein the method for pharmacokinetic parameter prediction of the peptide sequence is applied to Mammalia.

16. The method of claim 3, wherein the method for pharmacokinetic parameter prediction of the peptide sequence is applied to human.

17. The program storage medium for pharmacokinetic parameter prediction of the peptide sequence by mathematical model, comprising the processes of: acquiring a variety of peptide sequence having specific features by the experimental technique; acquiring, on the basis of the sequence, a variety of peptide sequences lacking the specific features; storing the acquired peptide sequences as each set respectively, followed by randomly extracting peptide sequences in the constant ratio to divide into a training set and a test set of mathematical model; allowing individual peptide sequence descriptor values and an activity value; training the set of training peptide by mathematical model; predicting pharmacokinetic parameter of the set of test peptide by the trained mathematical model; and validating the trained mathematical model.
